(19) United States
(12) Patent Application Publication
(10) Pub. No.: US 2016/0140089 A1
(43) Pub. Date: May 19, 2016

(54) METHOD AND SYSTEM FOR MOBILE DEVICE OPERATION VIA TRANSITION TO ALTERNATE GESTURE INTERFACE

(71) Applicant: Kobo Incorporated, Toronto (CA)

(72) Inventor: James WU, Newmarket (CA)

(73) Assignee: KOBO INCORPORATED, Toronto (CA)

(21) Appl. No.: 14/540,286

(22) Filed: Nov. 13, 2014

(51) Int. Cl. G06F 17/22; G06F 3/0488; G06F 17/30

(52) U.S. Cl. CPC G06F 17/2235; G06F 17/30011; G06F 3/04883

(57) ABSTRACT

A computing device, or electronic personal display, includes a housing and a touch screen display. The housing includes a gesture sensitive housing portion. The processor is capable of detecting a presence of one or more extraneous objects on the display screen. In response to detecting the presence of the one or more extraneous objects on the display screen, an the input command from the first gesture interface is nullified , and instead is associated with a second gesture received at the gesture-sensitive housing portion for performing a given output operation.

### TECHNICAL FIELD

Examples described herein relate to a system and method for transitioning a mobile computing device to operation in an alternate interface mode.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers and electronic readers (e-readers) such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, Kobo Aura H2O and the like).

Some electronic personal display devices are purpose built devices designed to perform especially well at displaying digitally-stored content for reading or viewing thereon. For example, a purpose build device may include a display that reduces glare, performs well in high lighting conditions, and/or mimics the look of text as presented via actual discrete pages of paper. While such purpose built devices may excel at displaying content for a user to read, they may also perform other functions, such as displaying images, emitting audio, recording audio, and web surfing, among others.

There are also numerous kinds of consumer devices that can receive services and resources from a network service. Such devices can operate applications or provide other functionality that links a device to a particular account of a specific service. For example, the electronic reader (e-reader) devices typically link to an online bookstore, and media playback devices often include applications that enable the user to access an online media electronic library (or e-library). In this context, the user accounts can enable the user to receive the full benefit and functionality of the device.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description of the drawings should not be understood as being drawn to scale unless specifically noted.

FIG. 1 illustrates a system utilizing applications and providing e-book services on a computing device for transitioning to an alternate touch-based mode of operation, according to an embodiment.

FIG. 2 illustrates a schematic configuration of a computing device for transitioning to an alternate touch-based mode of operation, according to an embodiment.

FIG. 3 illustrates an example architecture of a computing device for transitioning to an alternate mode of operation, according to an embodiment.

### DETAILED DESCRIPTION

Embodiments described herein provide for a computing device that is operable even when water and/or other persistent objects are present on the surface of a display of the computing device. More specifically, the computing device may detect a presence of extraneous objects (e.g., such as water, dirt, or debris) on a surface of the display screen, and perform one or more operations to mitigate or overcome the presence of such extraneous objects in order to maintain a functionality for use as intended, and/or viewability of content displayed on the display screen. For example, upon detecting the presence of one or more extraneous objects, such as water droplets, debris or dirt, certain settings or configurations of the computing device may be automatically adjusted, thereby invoking operation via an alternate user interface based on a gesture-sensitive housing portion of the computing device, whereby gestures from a display screen-based interface mode of operation are nullified as valid user input commands to perform a given processor output operation; in lieu thereof, an alternate user interface using the gesture sensitive housing portion becomes associated with, and capable of, effecting the processor output operation.

“E-books” are a form of electronic publication content stored in digital format in a computer non-transitory memory, viewable on a computing device with suitable functionality. An e-book can correspond to, or mimic, the paginated format of a printed publication for viewing, such as provided by printed literary works (e.g., novels) and periodicals (e.g., magazines, comic books, journals, etc.). Optionally, some e-books may have chapter designations, as well as content that corresponds to graphics or images (e.g., such as in the case of magazines or comic books). Multi-function devices, such as cellular-telephony or messaging devices, can utilize specialized applications (e.g., specialized e-reading application software) to view e-books in a format that mimics the paginated printed publication. Still further, some devices (sometimes labeled as “e-readers”) can display digitally-stored content in a more reading-centric manner, while also providing, via a user input interface, the ability to manipulate that content for viewing, such as via discrete successive pages.

An “e-reading device”, also referred to herein as an electronic personal display, can refer to any computing device that can display or otherwise render an e-book. By way of example, an e-reading device can include a mobile computing device on which an e-reading application can be executed to render content that includes e-books (e.g., comic books, magazines, etc.). Such mobile computing devices can include, for example, a multi-functional computing device for cellular telephony/messaging (e.g., feature phone or smart phone), a tablet computer device, an ultra=mobile computing device, or a wearable computing device with a form factor of a wearable accessory device (e.g., smart watch or bracelet, glass-wear integrated with a computing device, etc.). As another example, an e-reading device can include an e-reader device, such as a purpose-built device that is optimized for an e-reading experience (e.g., with E-ink displays).

### System and Hardware Description

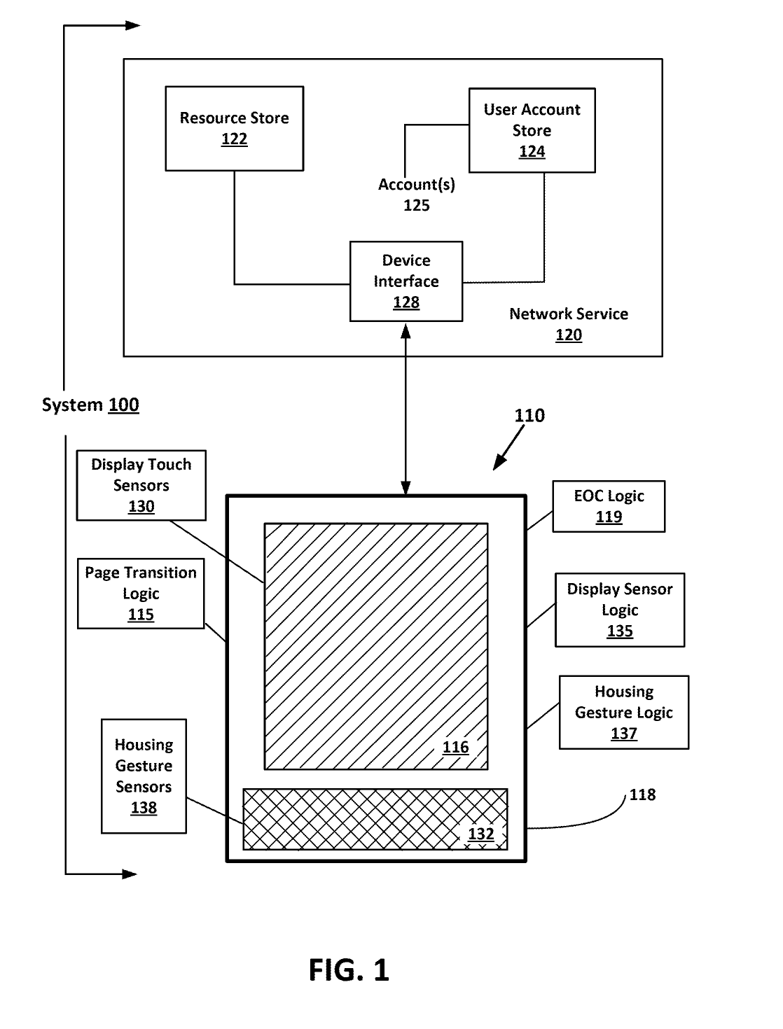

FIG. 1 illustrates a system 100 for utilizing applications and providing e-book services on a computing device, according to an embodiment. In an example of FIG. 1, system 100 includes an electronic personal display device, shown by way of example as an e-reading device 110, and a network service 120. The network service 120 can include multiple servers and other computing resources that provide various services in connection with one or more applications that are installed on the e-reading device 110. By way of example, in one implementation, the network service 120 can provide e-book services in communication with e-reading device 110. The e-book services provided through network service 120 can, for example, include services in which e-books are sold, shared, downloaded and/or stored. More generally, the network service 120 can provide various other content services, including content rendering services (e.g., streaming media) or other network-application environments or services.

The e-reading device 110 can correspond to any electronic personal display device on which applications and application resources (e.g., e-books, media files, documents) can be rendered and consumed. For example, the e-reading device 110 can correspond to a tablet or a telephony/messaging device (e.g., smart phone). In one implementation, for example, e-reading device 110 can run an e-reader application that links the device to the network service 120 and enables e-books provided through the service to be viewed and consumed. In another implementation, the e-reading device 110 can run a media playback or streaming application that receives files or streaming data from the network service 120. By way of example, the e-reading device 110 can be equipped with hardware and software to optimize certain application activities, such as reading electronic content (e.g., e-books). For example, the e-reading device 110 can have a tablet-like form factor, although variations are possible. In some cases, the e-reading device 110 can also have an E-ink display.

In additional detail, the network service 120 can include a device interface 128, a resource store 122 and a user account store 124. The user account store 124 can associate the e-reading device 110 with a user and with an account 125. The account 125 can also be associated with one or more application resources (e.g., e-books), which can be stored in the resource store 122. The device interface 128 can handle requests from the e-reading device 110, and further interface the requests of the device with services and functionality of the network service 120. The device interface 128 can utilize information provided with a user account 125 in order to enable services, such as purchasing downloads or determining what e-books and content items are associated with the user device. Additionally, the device interface 128 can provide the e-reading device 110 with access to the content store 122, which can include, for example, an online store. The device interface 128 can handle input to identify content items (e.g., e-books), and further to link content items to the account 125 of the user.

Yet further, the user account store 124 can retain metadata for individual accounts 125 to identify resources that have been purchased or made available for consumption for a given account. The e-reading device 110 may be associated with the user account 125, and multiple devices may be associated with the same account. As described in greater detail below, the e-reading device 110 can store resources (e.g., e-books) that are purchased or otherwise made available to the user of the e-reading device 110, as well as to archive e-books and other digital content items that have been purchased for the user account 125, but are not stored on the particular computing device.

With reference to an example of FIG. 1, e-reading device 110 can include a display screen 116 and a housing 118. In an embodiment, the display screen 116 is touch-sensitive, to process touch inputs including gestures (e.g., swipes). For example, the display screen 116 may be integrated with one or more touch sensors 138 to provide a touch sensing region on a surface of the display screen 116. For some embodiments, the one or more touch sensors 138 may include capacitive sensors that can sense or detect a human body's capacitance as input. In the example of FIG. 1, the touch-sensing region coincides with a substantial surface area, if not all, of the display screen 116.

Additionally, the housing 118 can also be integrated with gesture sensors 138 to provide one or more touch sensing regions 132 on the bezel, front surface, a lateral surface or edge, and/or a rear surface of the housing 118. In some embodiments, the e-reader device 110 includes housing gesture logic 137 that monitors for touch gesture input provided through the housing sensor component 138, and further processes the input as a particular input or type of input. In one implementation, the housing gesture logic 137 can be integrated with the housing sensors 138. For example, the housing sensor components 138 can be provided as a modular component that includes integrated circuits or other hardware logic, and such resources can provide some or all of the housing sensor logic (137. For example, integrated circuits of the housing sensor component 138 can monitor for touch input and/or process the touch input as being of a particular kind.

In some embodiments, the e-reading device 110 includes features for providing functionality related to displaying paginated content. The e-reading device 110 can include page transitioning logic 115, which enables the user to transition through paginated content. The e-reading device 110 can display pages from e-books, and enable the user to transition from one page state to another. In particular, an e-book can provide content that is rendered sequentially in pages, and the e-book can display page states in the foam of single pages, multiple pages or portions thereof. Accordingly, a given page state can coincide with, for example, a single page, or two or more pages displayed at once. The page transitioning logic 115 can operate to enable the user to transition from a given page state to another page state. In some implementations, the page transitioning logic 115 enables single page transitions, chapter transitions, or cluster transitions (multiple pages at one time).

The page transitioning logic 115 can be responsive to various kinds of interfaces and actions in order to enable page transitioning. In one implementation, the user can signal a page transition event to transition page states by, for example, interacting with the touch-sensing region of the display screen 116. For example, the user may swipe the surface of the display screen 116 in a particular direction (e.g., up, down, left, or right) to indicate a sequential direction of a page transition. In variations, the user can specify different kinds of page transitioning input (e.g., single page turns, multiple page turns, chapter turns, etc.) through different kinds of input. Additionally, the page turn input of the user can be provided with a magnitude to indicate a magnitude (e.g., number of pages) in the transition of the page state. For example, a user can touch and hold the surface of the display screen 116 in order to cause a cluster or chapter page state transition, while a tap in the same region can effect a single page state transition (e.g., from one page to the next in sequence). In another example, a user can specify page turns of different kinds or magnitudes through single taps, sequenced taps or patterned taps on the touch sensing region of the display screen 116.

According to some embodiments, the e-reader device 110 can integrate one or more types of touch-sensitive technologies in order to provide touch-sensitivity on housing sensing portion 132. It should be appreciated that a variety of touch sensing technologies may be utilized to provide touch-sensitivity at housing sensing portion 132. By way of example, housing gesture touch-sensors 138 used at housing sensing portion 132 can utilize resistive touch sensors; capacitive touch sensors (using self and/or mutual capacitance); inductive touch sensors; or infrared touch sensors. For example, housing sensing portion 132 can employ resistive sensors, which can respond to pressure applied to the front surface of housing 118 in areas coinciding with the sensing regions 132. In a variation, the housing sensing portion 132 can be implemented using a grid pattern of electrical elements which detect capacitance inherent in human skin. Alternatively, housing sensing portion 132 can be implemented using a grid pattern of electrical elements which are placed on or just beneath the front surface housing portion 132, and which deforms sufficiently on contact to detect touch from an object such as a finger. More generally, touch-sensing technologies for implementing housing sensing portion 132 can employ resistive touch sensors, capacitive touch sensors (using self and/or mutual capacitance), inductive touch sensors, or infrared touch sensors.

According to some embodiments, the e-reading device 110 includes display sensor logic 135 to detect and interpret user input or user input commands made through interaction with the touch sensors 138. By way of example, the display sensor logic 135 can detect a user making contact with the touch sensing region of the display screen 116. More specifically, the display sensor logic 135 can detect taps, an initial tap held in sustained contact or proximity with display screen 116 (otherwise known as a “long press”), multiple taps, and/or swiping gesture actions made through user interaction with the touch sensing region of the display screen 116. Furthermore, the display sensor logic 135 can interpret such interactions in a variety of ways. For example, each interaction may be interpreted as a particular type of user input corresponding with a change in state of the display 116.

For some embodiments, the display sensor logic 135 may further detect the presence of water, dirt, debris, and/or other extraneous objects on the surface of the display 116. For example, the display sensor logic 135 may be integrated with a water-sensitive switch (e.g., such as an optical rain sensor) to detect an accumulation of water on the surface of the display 116. In a particular embodiment, the display sensor logic 135 may interpret simultaneous contact with multiple touch sensors 138 as a type of non-user input. For example, the multi-sensor contact may be provided, in part, by water and/or other unwanted or extraneous objects (e.g., dirt, debris, etc.) interacting with the touch sensors 138. Specifically, the e-reading device 110 may then determine, based on the multi-sensor contact, that at least a portion of the multi-sensor contact is attributable to presence of water and/or other extraneous objects on the surface of the display 116.

E-reading device 110 further includes housing gesture logic 137 to interpret user input gestures as commands based on detection by housing gesture sensor(s) 136 at gesture sensitive housing portion 132. For example, input gestures performed at gesture sensitive housing portion 132 of e-reading device 110 such as a tap, a directional swipe, and a series of taps may be detected via housing gesture sensors 138 and interpreted as respective input commands by housing gesture logic 137.

E-reading device 110 further includes extraneous object configuration (EOC) logic 119 to adjust one or more settings of the e-reading device 110 to account for the presence of water and/or other extraneous objects being in contact with the display screen 116. For example, upon detecting the presence of water and/or other extraneous objects on the surface of the display screen 116, the EOC logic 119 may power off the e-reading device 110 to prevent malfunctioning and/or damage to the device 110. EOC logic 119 may then reconfigure the e-reading device 110 by invalidating or dissociating a touch screen gesture from being interpreted as a valid input command, and in lieu thereof, associate an alternative type of user interactions as valid input commands, e.g., motion inputs that are detected via the motion sensor(s) 136 will now be associated with any given input command previously enacted via the touch sensors 138 and display sensor logic 135. This enables a user to continue operating the e-reading device 110 even with the water and/or other extraneous objects present on the surface of the display screen 116, albeit by using the alternate type of user interaction.

One or more embodiments of housing gesture logic 137 and EOC logic 119 as described herein may be implemented by computing device 110 using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments of housing gesture logic 137 and EOC logic 119 as described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs, or a computer usable carrier medium capable of carrying such a program.

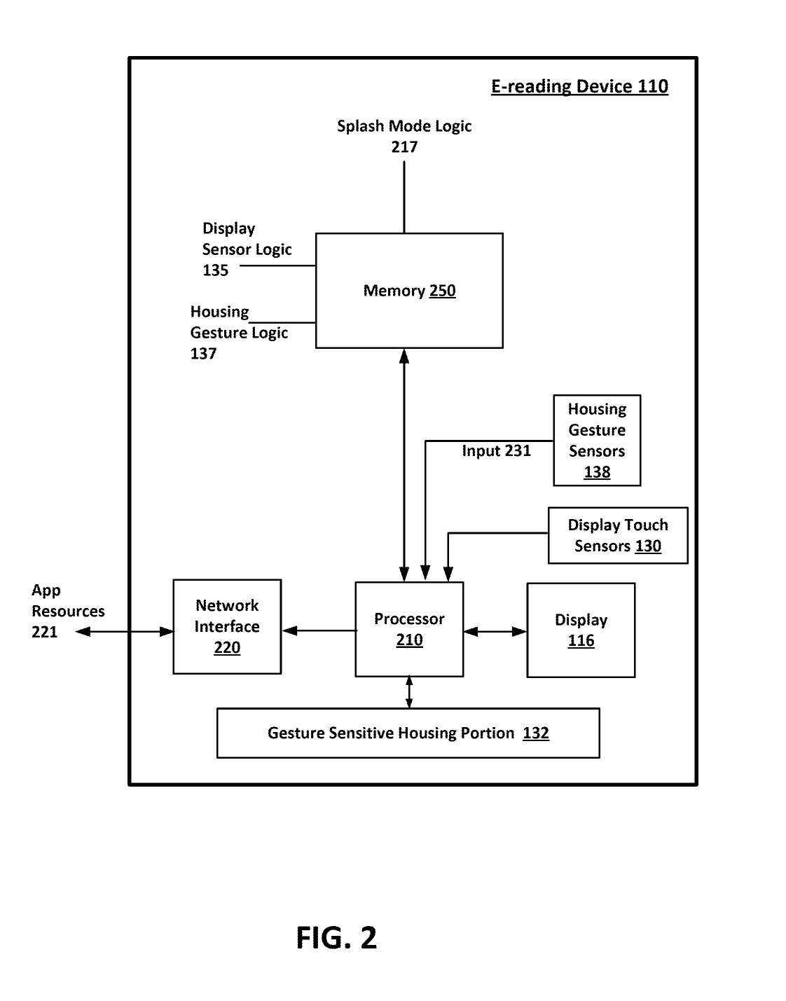

FIG. 2 illustrates a schematic architecture, in one embodiment, of e-reading device 110 as described above with respect to FIG. 1. With reference to FIG. 2, e-reading device 110 further includes a processor 210, a memory 250 storing instructions, and logic pertaining at least to display sensor logic 135, extraneous object logic 119 and housing gesture logic 137.

The processor 210 can implement functionality using the logic and instructions stored in the memory 250. Additionally, in some implementations, the processor 210 utilizes the network interface 220 to communicate with the network service 120 (see FIG. 1). More specifically, the e-reading device 110 can access the network service 120 to receive various kinds of resources (e.g., digital content items such as e-books, configuration files, account information), as well as to provide information (e.g., user account information, service requests etc.). For example, e-reading device 110 can receive application resources 221, such as e-books or media files, that the user elects to purchase or otherwise download via the network service 120. The application resources 221 that are downloaded onto the e-reading device 110 can be stored in the memory 250.

In some implementations, the display 116 can correspond to, for example, a liquid crystal display (LCD) or light emitting diode (LED) display that illuminates in order to provide content generated from processor 210. In some implementations, the display 116 can be touch-sensitive. For example, in some embodiments, one or more of the touch sensor components 138 may be integrated with the display 116. In other embodiments, the touch sensor components 138 may be provided (e.g., as a layer) above or below the display 116 such that individual touch sensor components 116 track different regions of the display 116. Further, in some variations, the display 116 can correspond to an electronic paper type display, which mimics conventional paper in the manner in which content is displayed. Examples of such display technologies include electrophoretic displays, electro-wetting displays, and electro-fluidic displays.

The processor 210 can receive input from various sources, including the touch sensor components 138, the display 116, from housing gesture sensors 138 at gesture sensitive housing portion 132 and/or other input mechanisms (e.g., buttons, keyboard, mouse, microphone, etc.). With reference to examples described herein, the processor 210 can respond to input 231 detected at housing gesture sensors 138. In some embodiments, the processor 210 responds to inputs 231 from the housing sensor 138 in order to facilitate or enhance e-book activities such as generating e-book content on the display 116, performing page transitions of the displayed e-book content, powering on or off device 110 and/or display 116, activating a screen saver, launching or closing an application, and/or otherwise altering a state of the display 116.

Still with reference to FIG. 2 and the examples described herein, the processor 210 can respond to input 231 from the housing gesture sensor components 138. In some embodiments, the e-reader device 110 includes housing gesture logic 137 that monitors for touch gesture input provided through the housing sensor component 138, and further processes the input as a particular input or type of input. In one implementation, the housing gesture logic 137 can be integrated with the housing sensors 138. For example, the housing sensor components 138 can be provided as a modular component that includes integrated circuits or other hardware logic, and such resources can provide some or all of the housing sensor logic (137. For example, integrated circuits of the housing sensor component 138 can monitor for touch input and/or process the touch input as being of a particular kind. In variations, some or all of the housing gesture logic 137 is implemented with the processor 210 (which utilizes instructions stored in the memory 250), or with an alternative processing resource.

In some embodiments, the memory 250 may store display sensor logic 135 that monitors for user interactions detected through the touch sensor components 138 of display screen 135, and further processes the user interactions as a particular input or type of input. In an alternative embodiment, the display sensor logic 135 may be integrated with the touch sensor components 138. For example, the touch sensor components 138 can be provided as a modular component that includes integrated circuits or other hardware logic, and such resources can provide some or all of the display sensor logic 135. In variations, some or all of the display sensor logic 135 may be implemented with the processor 210 (which utilizes instructions stored in the memory 250), or with an alternative processing resource.

Still with regard to FIG. 2, a touch gesture performed on gesture sensitive housing portion 132 (e.g., housing gesture input 231) can be detected via housing gesture sensors 138. In particular, the touch gesture input can be detected with housing gesture sensors 138 that are embedded or integrated into gesture sensitive housing portion 132 of computing device 110 The housing gesture logic 137 can detect one or more aspects about the housing sensor input 231. In particular, the housing gesture logic 137 can detect a directional aspect of the input 231 The directional aspect can correspond to, for example, whether the input is vertical (or along a length of the housing), sideways (along a lateral edge extending from sidewall to sidewall), whether the input is downward, or whether the input is upward. As an alternative or variation, housing gesture logic 137 can detect whether the housing sensor input 231 is a gesture (e.g., pinch, tap, multi-tap, or long press). The housing gesture logic 137 can include logic to interpret the gesture. In variations, other aspects can also be detected (526), such as velocity or positioning of the finger (or other contact object) as a given moment upon housing portion 132.

For some embodiments, the display sensor logic 135 may detect the presence of water and/or other extraneous objects, including debris and dirt, on the surface of the display 116. For example, the display sensor logic 135 may determine that extraneous objects are present on the surface of the display 116 based on a number of touch-based interactions detected via the touch sensors 138 and/or a contact duration (e.g., a length of time for which contact is maintained with a corresponding touch sensor 138) associated with each interaction. More specifically, the display sensor logic 135 may detect the presence of water and/or other extraneous objects if a detected interaction falls outside a set of known gestures (e.g., gestures that are recognized by the e-reading device 110). Such embodiments are discussed in greater detail, for example, in co-pending U.S. patent application Ser. No. 14/498,661, titled “Method and System for Sensing Water, Debris or Other Extraneous Objects on a Display Screen,” filed Sep. 26, 2014, which is hereby incorporated by reference in its entirety.

For some embodiments, the display sensor logic 135 further includes splash mode (SM) logic 217 for adjusting one or more settings of the e-reading device 110 in response to detecting the presence of water and/or other extraneous objects on the surface of the display 116. For example, the splash mode logic 217 may configure the e-reading device 110 to operate in a “splash mode” when water and/or other extraneous objects are present (e.g., “splashed”) on the surface of the display 116. While operating in splash mode, one or more device configurations may be altered or reconfigured to enable the e-reading device 110 to be continuously operable even while water and/or other extraneous objects are present on the surface of the display 116. More specifically, the splash mode logic 217 may perform one or more operations to mitigate or overcome the presence of extraneous objects (e.g., such as water) on the surface of the display 116. Accordingly, the splash mode logic 217 may be activated by the display sensor logic 135 upon detecting the presence of extraneous objects on the surface of the display 116.

For some embodiments, the splash mode logic 217 may reconfigure one or more actions (e.g., input responses) that are to be performed by the e-reading device 110 in response to user inputs. For example, the splash mode logic 217 may disable or dissociate certain actions (e.g., such as performing multi-page and/or chapter transitions) that are triggered by user touch interactions (e.g., requiring concurrent contact at multiple distinct locations on the display 116) and/or persistent user interactions (e.g., requiring continuous contact with the touch sensors 138 over a given duration) because such interactions could be misinterpreted by the gesture logic 215 given the presence of extraneous objects on the surface of the display 116. The disabling or dissociation may be accomplished by terminating electrical power selectively to those components implicated in a portion of circuitry, using interrupt-based logic to selectively disable the components involved, such as touch sensors 138 disposed in association with display screen 116.

Additionally, and/or alternatively, the splash mode logic 217 may enable a new set of actions to be performed by the e-reading device 110. For example, the splash mode logic 217 may remap, or associate, one or more user input commands to a new set of motion actions as detected by motion sensor(s) 136. With housing gesture sensors 138 activated for use in conjunction with splash mode 217, a new set of gesture actions performable on gesture sensitive housing portion 132 (e.g., such as a tap, a series of taps, a long press, a directionally enacted swipe) of e-reading device 110 for interpretation as respective input commands by housing gesture logic 137) may be performed on the e-reading device 110 and be validated or recognized only when water and/or other extraneous objects are present on the surface of the display 116. More specifically, the new set of gesture actions performable at gesture sensitive housing portion 132 may enable the e-reading device 110 to operate in an optimized manner while the water and/or other extraneous objects are present.

### Methodology

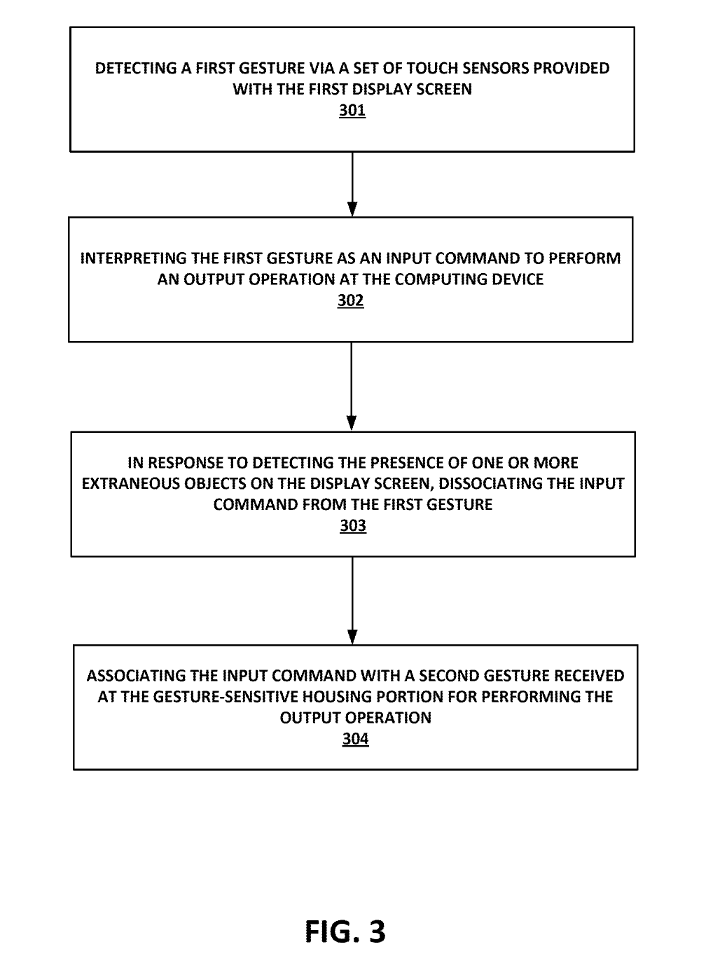

FIG. 3 illustrates a method of operating an e-reading device 110 to an alternate gesture mode when water and/or other extraneous objects are present on the display 116, according to one or more embodiments. In describing the example of FIG. 3, reference may be made to components such as described with FIGS. 1 and 2 for purposes of illustrating suitable components and logic modules for performing a step or sub-step being described.

With reference to the example of FIG. 3, the e-reading device 110 may detect the presence of one or more extraneous objects on a surface of the display 116 (610). For some embodiments, the display sensor logic 135 may detect the presence of extraneous objects on the surface of the display 116 based on a number of touch-based interactions detected via the touch sensors 138 and/or a contact duration associated with each of the interactions. For example, the display sensor logic 135 may determine that extraneous objects are present on the surface of the display 116 if a detected interaction falls outside a set of known gestures.

At step 301, a gesture upon display screen 116 is detected via the set of touch sensors 130 is interpreted as an input command to perform an output operation at the computing device 110.

At step 302, the gesture enacted at the display screen is interpreted by display sensor logic 135 as an input gesture command to perform an associated output operation, via processor 210, at computing device 110.

At step 303, splash mode logic 217 detects the presence of one or more extraneous objects on a surface of the display 116 in response to detecting the presence of the one or more extraneous objects on the display screen, and in response thereto, disables or dissociates certain user input commands associated with touch gestures such as a tap, a sustained touch, a swipe or some combination thereof, received at display screen 116 as detected from display touch sensors 130.

At step 304, splash mode logic 217 in conjunction with housing gesture logic 137 then reconfigures or remaps the set of user input commands by associating ones of the set with respective motion input commands as detected via housing gesture sensors 138. Example gestures on the housing portion 132 may include a tap, a series of taps, a number of simultaneous taps, a directionally enacted swipe, and a long press, or some combination thereof, as detected via housing gesture sensors 138 and interpreted by housing gesture logic 137 to accomplish respective output operations for e-reading actions, such as turning a page (whether advancing or backwards), placing a bookmark on a given page or page portion, placing the e-reader device in a sleep state, a power-on state or a power-off state, and navigating from the e-book being read to access and display an e-library collection of e-books that may be associated with user account store 124.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments.

What is claimed is:

1. A method executed in a processor of a computing device, the computing device including a memory storing instructions, a display screen having touch functionality, and a gesture-sensitive housing portion, the processor capable of detecting a presence of one or more extraneous objects on the display screen, the method comprising:
detecting a first gesture via a set of touch sensors provided with the display screen;
interpreting the first gesture as an input command to perform an output operation at the computing device;
in response to detecting the presence of the one or more extraneous objects on the display screen, dissociating the input command from the first gesture; and
associating the input command with a second gesture received at the gesture-sensitive housing portion for performing the output operation.

2. The method of claim 1, wherein the first gesture is interpreted as an input command to enact a page transition operation upon digital content displayable as a sequence of pages upon the display screen.

3. The method of claim 3 wherein the second gesture received at the gesture-sensitive housing portion is one of a tap, a long press and a swipe.

4. The method of claim 3 wherein the output operation comprises a bookmark operation associated with a page in the sequence of pages.

5. The method of claim 3 wherein the output operation comprises a return to an e-library collection of e-books.

6. The method of claim 1, wherein the output operation comprises a power-on state change of the computing device.

7. The method of claim 1, wherein the output operation comprises a power-off state change of the computing device.

8. The method of claim 1 wherein the processor detects an aspect of the second gesture received at the gesture-sensitive housing portion as having one of a direction and a swipe speed. The method of claim 1 wherein the gesture sensitive housing portion is provided at one of:
a front surface, a lateral surface, and a rear surface of the computing device.

10. A computing device comprising:
a display screen including touch functionality;
a housing that at least partially circumvents the display screen, the housing including a gesture sensitive portion; and
a processor provided within the housing that detects a presence of one or more extraneous objects on the display screen, the processor further operable to:
detect a first gesture via a set of touch sensors provided with the display screen;
interpret the first gesture as an input command to perform an output operation at the computing device;
in response to detecting the presence of the one or more extraneous objects on the display screen, dissociate the input command from the first gesture; and
associate the input command with a second gesture received at the gesture-sensitive housing portion for performing the output operation.

11. The computing device of claim 10 wherein the second gesture received at the gesture-sensitive housing portion is one of a tap, a long press and a swipe.

12. The computing device of claim 10 wherein the first gesture is interpreted as an input command to enact a page transition operation upon digital content displayable as a sequence of pages upon the display screen.

13. The computing device of claim 12 wherein the output operation comprises a bookmark operation associated with a page in the sequence of pages.

14. The computing device of claim 12 wherein the output operation comprises a return to an e-library collection of e-books.

15. The computing device of claim 10 wherein the output operation comprises a power-on state change of the computing device.

16. The computing device of claim 10 wherein the output operation comprises a power-off state change of the computing device.

17. The computing device of claim 9 wherein the processor detects an aspect of the second gesture received at the gesture-sensitive housing portion as having one of a direction and a swipe speed.

18. The computing device of claim 9 wherein the gesture sensitive housing portion is provided at one of: a front surface, a lateral surface, and a rear surface of the computing device.

19. A non-transitory computer-readable medium storing instructions that, when executed by a processor of a computing device, cause the processor to perform operations that include:
detecting a first gesture via a set of touch sensors provided with a display screen of the computing device;
interpreting the first gesture as an input command to perform an output operation at the computing device;
in response to detecting a presence of one or more extraneous objects on the display screen, dissociating the input command from the first gesture; and
associating the input command with a second gesture received at a gesture-sensitive housing portion of the computing device for performing the output operation.
